(19) United States
(12) Patent Application Publication
(10) Pub. No.: US 2005/0192894 A1
(43) Pub. Date: Sep. 1, 2005

(54) Checkpoint processing engine

(75) Inventors: Moshe Klein, Woodland Hills, CA (US); Alon Shwartz, Woodland Hills, CA (US); Jim Zafrani, Woodland Hills, CA (US)

Correspondence Address: MARVIN H. KLEINBERG;KLEINBERG & LERNER, LLP, 2049 Century Park East, Suite 1080, Los Angeles, CA, 90067, US

(73) Assignee: Synthean Inc.

(21) Appl. No.: 11/047,061

(22) Filed: Jan. 31, 2005

Related U.S. Application Data
(60) Provisional application No. 60/540,960, filed on Jan. 30, 2004.
(60) Provisional application No. 60/540,961, filed on Jan. 30, 2004.
(60) Provisional application No. 60/540,964, filed on Jan. 30, 2004.
(60) Provisional application No. 60/540,959, filed on Jan. 30, 2004.
(60) Provisional application No. 60/540,962, filed on Jan. 30, 2004.

(51) Int. Cl. G06F 17/60

(52) U.S. Cl. 705/39; 705/35

(57) ABSTRACT

A method of correlating at least one data element used by at least one step of a business activity with an instance of said business activity, includes the steps of creating a unique identifier which is distinct from the data element, creating a data table of the data element associated to the unique identifier, identifying the data element used within the step, and correlating the step with the desired instance of said business activity utilizing the data element within the step, compiling a summary of the instance of the business activity and utilizing the summary to analyze the instance of the business activity.

This application claims priority as a continuation in part of the provisional patent applications: Checkpoint Processing Engine, Ser. No. 60/540,959 filed Jan. 30, 2004; Event Capture Engine, Ser. No. 60/540,961 filed Jan. 30, 2004; Information Provider Engine, Ser. No. 60/540,960 filed Jan. 30, 2004; Business Activity Architect, Ser. No. 60/540,964 filed Jan. 30, 2004; Transaction Processing Engine, Ser. No. 60/540,962 filed Jan. 30, 2004 and the non-provisional patent application Universal Transaction Identifier Ser. No. 10/898,464 fild Jul. 23, 2004.

### BACKGROUND

1. Field of the Invention

The present invention relates to business processes, and more specifically to a system for processing data generated within each event within an instance of a business activity within an IT infrastructure.

2. Background of the Invention

Businesses operate via business activities, which are complex composites of sub- or micro-processes logically connected in the context of a common objective. For example, for a user of an internet website who is ordering a product, several different and distinct processes take place that all relate to the single transaction of purchasing the product. A web server delivers web pages with the requested content to the user. A database server provides some of the content. A credit card verification server ensures that payment is validated. A shipping server might take care of automating the shipping process. Finally, an inventory server could decrement the inventory list for the item demonstrating that one has been purchased. Any number of other servers and networked interactions can take place in effecting a single transaction.

In the prior art, the tracking of a single instance of a business activity has been relatively difficult. Capturing the data associated with each step in an instance of a business activity has been even more difficult. In prior art solutions, a single unique transaction identifier has been required to be passed from each server to server or process to process along the way to the completion of the entire instance of the business activity. Alternatively, an event within an instance of a business activity would be evaluated by going to the server or process that failed and receiving a single report from that server or process. For example, if a credit card server failed to properly process a charge to a customer, the only report of what occurred would exist in the records of the credit card server itself. This problem is only exacerbated when multiple instances of business activities fail at a particular server or process or several servers or processes and the business needs timely information in order to address these issues efficiently and effectively.

It is therefore an object of the present invention to provide a means by which each event and all relevant associated event data used in the event may be captured for each instance of a business activity. These and other objectives of the present invention will become apparent from the following description of the invention.

### SUMMARY OF THE INVENTION

A method of determining when an process event has occurred, extracting business data from the event, associating the data with a particular event definition to prepare for correlation of that data to a specific instance of a business activity or to a cluster of activities taking place on a particular server or group of servers and performing further processing based on validation rules, action rules or corrective action scripts.

### BRIEF DESCRIPTION OF THE DRAWINGS

FIG. 1 is a block diagram showing the elements of a computer system which can be used to implement the present invention.

FIG. 2 illustrates the elements of a sample IT infrastructure that may be used by a business enterprise.

FIG. 3 illustrates the various systems used in a representative business activity using the sample IT infrastructure.

FIG. 4 is an example business activity using the elements in FIG. 3.

FIG. 5 is an example of the elements that may be included in a transaction that may be in each event monitored by this process.

FIG. 6 is a depiction of the information technology infrastructure from FIG. 3 along with example event data that may be included in each element.

FIG. 7 is a flow-chart depicting the steps in the applying the checkpoint processing engine to the completion of an event.

FIG. 8a is an example of an abstract data elements definition.

FIG. 8b is an example of an abstract formatting of event data once a data element definition that has been applied.

### DETAILED DESCRIPTION OF THE INVENTION

The present invention provides a method, implemented on a computer system, for identifying a business event, extracting business data from that event for later correlation of that data to a specific instance of a business activity. In the following description, specific method steps and procedures are described in order to give a more thorough understanding of the present invention. In other instances, well known elements such as the computer's operating system and specific software functions are not described in detail so as not to obscure the present invention unnecessarily.

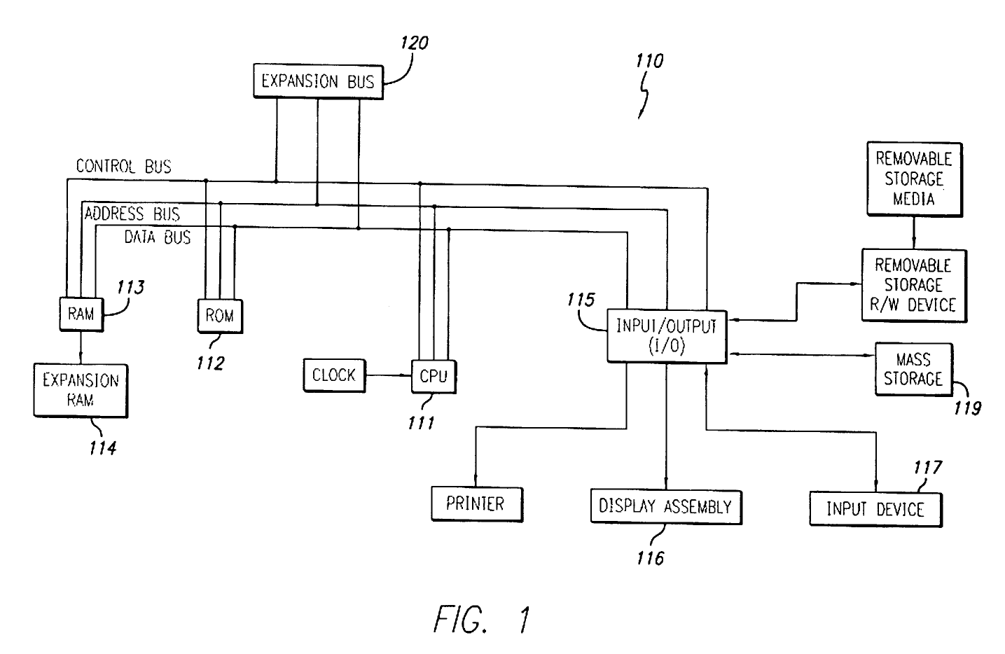

Referring first to FIG. 1, a block diagram of a general purpose computer system which may be used to implement the method of the present invention is illustrated. Specifically, FIG. 1 shows a general purpose computer system 110 for use in practicing the present invention. As shown in FIG. 1, computer system 110 includes a central processing unit (CPU) 111, read-only memory (ROM) 112, random access memory (RAM) 113, expansion RAM 114, input/output (I/O) circuitry 115, display assembly 116, input device 117, and expansion bus 120. The computer system 110 may also optionally include a mass storage unit 119 such as a disk drive unit or nonvolatile memory such as flash memory and a real-time clock 121.

Some type of mass storage 119 generally is considered desirable. However, mass storage 119 can be eliminated by providing a sufficient mount of RAM 113 and expansion RAM 114 to store user application programs and data. In that case, RAMs 113 and 114 can optionally be provided with a backup battery to prevent the loss of data even when computer system 110 is turned off. However, it is generally desirable to have some type of long term mass storage 119 such as a commercially available hard disk drive, nonvolatile memory such as flash memory, battery backed RAM, PC-data cards, or the like. The controlled vocabulary data: which is stored in the present invention will be generally stored on mass storage device 119.

In operation, information is input into the computer system 110 by typing on a keyboard, manipulating a mouse or trackball, or “writing” on a tablet or on a position-sensing screen of display assembly 116. CPU 111 then processes the data under control of an operating system and an application program, such as a program to perform steps of the inventive method described above, stored in ROM 112 and/or RAM 113. CPU 111 then typically produces data which is output to the display assembly 116 to produce appropriate images on its screen.

Suitable computers for use in implementing the present invention are well known in the art and may be obtained from various vendors. The preferred embodiment of the present invention is intended to be implemented on a personal computer system, web server or other business application server. Various other types of computers, however, may be used depending upon the size and complexity of the required tasks. Suitable computers include mainframe computers, multiprocessor computers and workstations.

The present invention can be utilized to enable a business enterprise to examine business activities in a more efficient and cost-effective manner. The term “business activity” as used herein refers to a logically related series of processes or functions that are performed by the business enterprise in combination to achieve a desired goal. For example, a business activity can be as simple as taking an order from a customer, and delivering a product in response. On the other hand a business activity can be as complex as all of the functions performed by a network of servers performing various functions in the completion of an online order for a product.

An “instance” of a business activity is all of the operations performed in completing one instance of the business activity. For example, as described above the business activity could be taking an order online and delivering a product. An instance of that business activity could be one individual's order for a specific product processed from start to finish including all of the processes in between. A business activity is the general case, whereas an instance of a business activity is the specific case. The business activity includes all of the processes necessary to complete one business activity in the general, whereas an instance of a business activity is each of those processes performed in one specific instance. In the case of the financial advisor example, the business activity would be advising the client and all of the functions and processes necessary to reach that objective. The instance of the business activity would be advising a specific client, using those functions and processes toward the goal of advising a specific client. Another instance of that business activity would be the advising of a different client, and so on. Alternatively, an instance of a business activity may also be called a transaction. One transaction could be the purchase of the product online, whereas the business activity would be the general definition of the processes and functions necessary to purchase a product online.

A “checkpoint” or “event” is a single step in the completion of an instance of a business activity. An example of a checkpoint could be the step in the purchase of a product over the internet, where the IT infrastructure of the business attempts to charge the specified amount to the customer. The attempt to charge the card would be a checkpoint. A successful charge made to the card would be another checkpoint. A timeout, no response from the credit card server for a specified period of time, would be a failed checkpoint. A typical timeout for a charge to a user's credit card could be as short as thirty seconds or as long as five minutes, depending upon the implementation.

Checkpoints are defined business activity-wide. So, for example, the process of charging the card, start to finish, would be one complete checkpoint definition. Each checkpoint is a single step in the process, but checkpoint definitions do not have meaning outside of other checkpoints, such as the request for the credit card charge only has meaning as a completed checkpoint once the successful charge is made or the credit card is declined or there is a timeout of the operation. At that point, the checkpoint has meaning in relation to other checkpoints in the process. This means that for each business activity there are several related checkpoint definitions. For the process of completing an order using the Internet, example checkpoints could be web server access request, web server access response, requesting a product be put into an online shopping cart, putting a product into an online shopping cart, attempting to charge the credit card for a specified amount, receiving a response to that credit card charge request, passing the request to ship along to a shipping department and actually shipping the product. Many other checkpoints in that business activity could also be included. Checkpoints are only completed (successful) or not-completed (failed) in instances of a business activity. A business activity is the abstract “definition” of each instance of a business activity. Thus in the abstract placing an order online, a checkpoint is only completed or not completed in the actual placing of a specific order.

“Event data” or “data” as used herein refers to data used or processed in the process of completing or attempting to complete a checkpoint. This data could be an individual's name, address and credit card number. This data could also be an internet protocol address for a user's computer or the server itself. Any data that the user of the checkpoint processing engine desires to log may be included in the “event data” that is created.

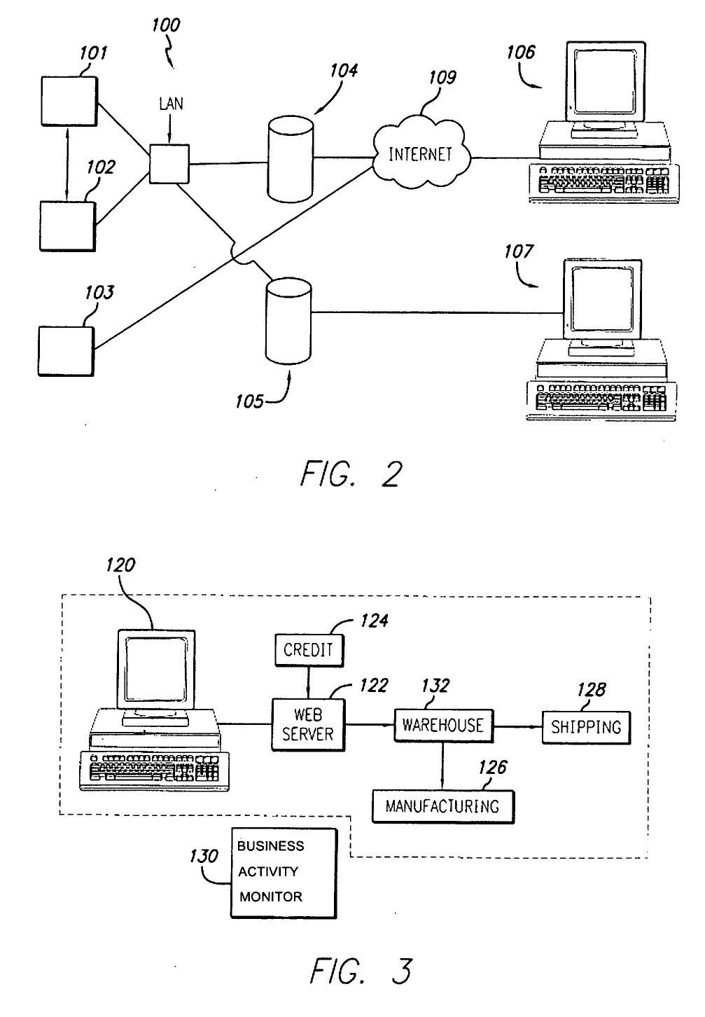

Many modern business activities are executed using a complex series of computers which make up an IT infrastructure. Referring next to FIG. 2, a representation of an example IT infrastructure 100 used by a business to complete a business activity is illustrated. The infrastructure may include a number of computer servers 101, 102, 103 which execute various functions or steps in a business activity. Although only three computer servers are illustrated in FIG. 2, it will be understood that a larger number of servers may be present in the infrastructure as required by the complexity of the business activity. The infrastructure may also include one or more databases 104, 105 for the storage and retrieval of data. Also Internet web servers 106, 107 may also be employed. Various other servers may also be included within an IT infrastructure.

Referring next to FIG. 3 a representative business activity is shown, including the elements on which that business activity is performed. The elements used in this example information technology infrastructure are a personal computer 120, a credit card processing server 124, a web server 122, a warehouse processing server 132, a shipping server 128, and a manufacturing server 126. The manufacturing server will likely be outside of, for example, any retailer's infrastructure, but communication will likely, take place between the company's infrastructure and the outside manufacturer's.

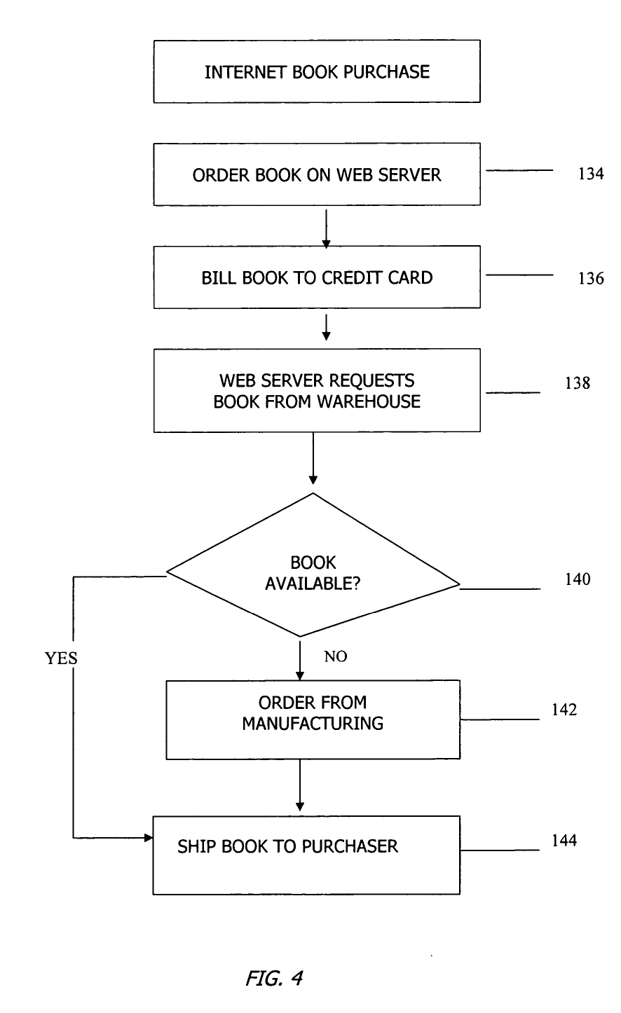

Referring to FIGS. 3 and 4, an example transaction is depicted. In this transaction, the user may place an order for a book 134 using her home computer 120 and using the web server 122. This order would include various data about the transaction including the user's name, address, credit card number, quality of product desired and any number of other data. Because this order is placed for this book using a credit card, the credit server 124 processes that card and bill the user's account 136. The web server 122, then passes data on to the warehouse processing server 132 in step 138, such as the item number, the person's name and address ordering the product. The warehouse server 132 determines if any of that book are available 140 and, if not, contacts the server of the publisher or manufacturer 126 of the book to place an order 142. Once the book is available, the warehouse server 132, then contacts its shipping server 128, sending name and address along for mailing purposes which ships the book to the purchaser 144.

Along the way, each step of this transaction passes data in various forms back and forth across a network. This is a very simple example. In any large-scale online retailing infrastructure, there are multiple web servers, accounting servers, database servers, order processing servers, data storage servers, and the like. Many times, entire clusters or clusters of clusters of servers are used to perform various functions in the online process. In industries other than online retailing, the servers may simply be web servers, file transfer protocol servers, virtual private network gateway servers, and internet portal servers that also pass similar data back and forth.

These examples make it easier to demonstrate that during this process, data is constantly being passed back and forth between the servers. This data is very rarely and almost never in the same or similar format. More recently efforts have been made to use a standard interface format between machines to aid in usability across different software platforms, but in many instances this is not available or simply impossible given the type of tasks being performed. One example of such an effort is the increasing use of extended markup language.

Referring again to FIG. 3, the checkpoint processing engine 130 runs on an additional server responsible for listening to receive information from the co-pending patent application entitled Event Capture Engine with Ser. No. 60/540,961. The checkpoint processing engine 130 may stand alone on its own server or be included on a single server along with several other related data processing applications involved in business activity monitoring. The checkpoint processing engine 130 waits to receive data from each individual event in every instance of a business activity. Referring again to the prior example, as the book is purchased, data is sent from the purchaser's home computer to the web server over the Internet. This data is encoded into a particular format for sending over the Internet, usually using secure hypertext transfer protocol (HTTPS). This data is sent using Transfer Control Protocol/Internet Protocol (TCP/IP). There are numerous other standards by which data is shared throughout the complete process from ordering to shipping. As this data is sent, these standards send other “control” data and “introductory” data along with the name, address, number of books and other details that the company would like to know about.

As this data is sent and received within a network, the checkpoint processing engine 130 “listens” to receive captured event data from another module described in the co-pending application entitled Event Capture Engine. It also receives the raw data and then performs steps to prepare the data so that the necessary components responsible for correlating this particular checkpoint to an overall transaction can take place. Each piece of processed checkpoint data is correlated to a particular transaction or instance of the business activity using the method and apparatus described in the co-pending application entitled Transaction Processing Engine with Ser. No. 60/540,962. The data, once it has been formatted for this later correlation to a completed transaction is stored for this later correlation.

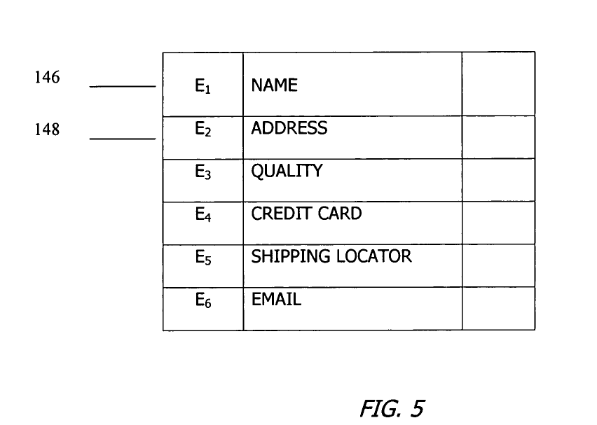

Referring next to FIG. 5, an example of the data that may be passed back and forth among various elements of the information technology infrastructure during a complete instance of a business activity is depicted. Depicted in element 146 is name. In element 148 is address. At each step along the way, all of the data will almost certainly never be sent at once or in an easily identifiable format. The checkpoint processing engine finds the portions of relevant event data that are passed in a particular step along the way to the completion of a single instance of a business activity. At each step toward the completion, the checkpoint processing engine finds each piece that is present and prepares it for later correlation to a completed instance of a business activity.

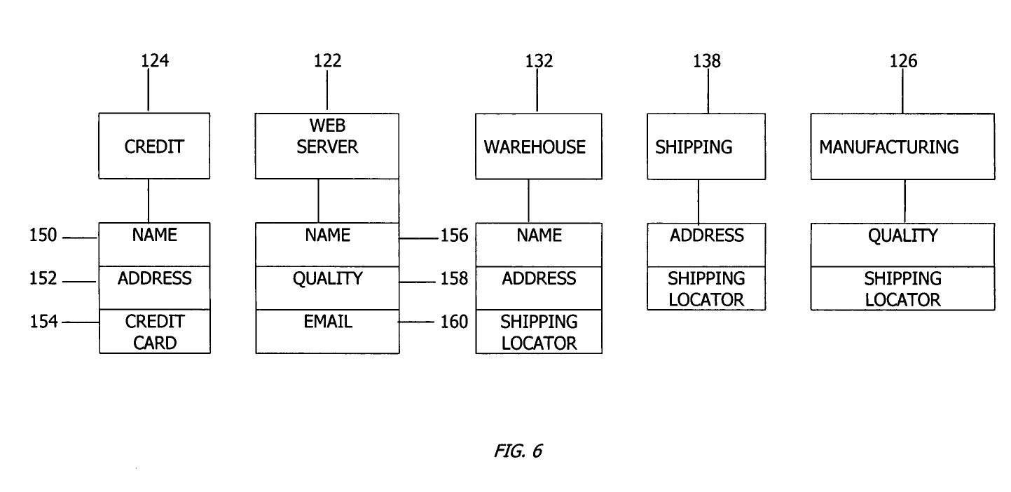

Referring now to FIG. 6, each of the information technology infrastructure elements depicted in FIG. 3 are included, along with the pieces of information each element gives or receives during a communication. For example, the credit card processing server 124 gives and receives the name 150, the address 152 and the credit card number 154. In this example, the credit card processing server 124 receives or transmits no other data elements. The web server 122, receives or transmits the name 156, a quality requirement of the product 158 and the email 160 of the purchaser. Therefore, no single portion of the infrastructure has access to a complete listing of data elements, as depicted in FIG. 5.

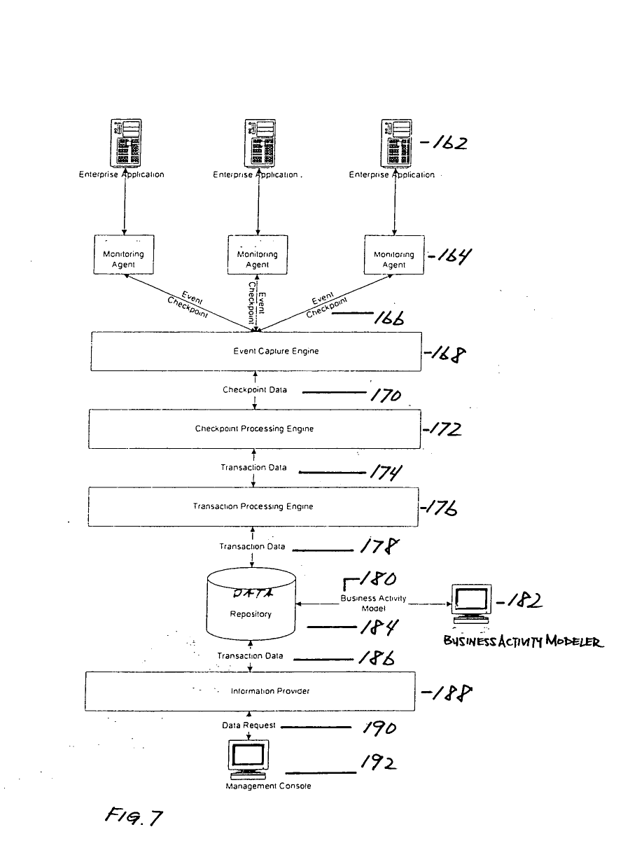

Referring now to FIG. 7, a flow-chart depicting the major steps associated with the checkpoint processing engine is shown. In the first step 162 of the preferred embodiment, an event is detected, monitored, and the data arrives at the checkpoint processing engine. The second step 164 is to parse the event data. In the preferred embodiment, there are two types of data in this event data, raw buffers of data captured directly from the event within an instance of a business activity and data, including a time stamp, of when and where the event was detected and captured. Other embodiments may include different or additional types of data or only one of the above-described types of data. The checkpoint processing engine parses the event data in step 164. In the preferred embodiment, one of two methods is used, either rule sets created by the user or using pre-existing scripts. Alternative methods may be employed in other embodiments, such as filters of the data, for example. An example rule set would watch for specific keywords in a buffer, log all of the data after that key word, then stop logging once it reaches another key word while reading. For example, a script could look for the text “Order Number: ” including the space. It may find that text in some data captured from a web server. The checkpoint processing engine would then begin logging the text after the space and stop once it reached the next space. So if the full text were “Order Number: 54930294 ”, then the logged text, that would be categorized as an Order Number would be simply “54930294.” A rule set could also look for specific elements within the event data or for a series of specific elements.

A script is generally more complicated than a rule set. A script might perform some reorganization of the data prior to pulling data out. It may reorder text or eliminate irrelevant data prior to extracting the relevant data. For example, a script may remove unnecessary content from a particular event data.

An important step in checkpoint processing is understanding the type of event data provided and recognizing the type of event data that has been captured. To perform this function in step 166, the checkpoint processing engine looks to see if a data elements definition exists. A data elements definition is simply a way of recognizing that a particular buffer of event data when captured is, for example, a web server's credit card processing request. In the preferred embodiment, a data elements definition is a template used to pull relevant data out of a particular type of event data. This event data may be of many forms, depending on the type of server being used or process taking place. In the preferred embodiment, many different templates are provided for numerous types of event data. Additionally, templates may be defined by the user in the preferred embodiment. In alternative embodiments, different methods of capturing the relevant data from an event data may be provided. Data may be filtered as it arrives based on pre-existing rules such that only a log of the relevant data is collected.

A data elements definition for a transaction involving a hypertext transfer protocol (HTTP) request would “know” where relevant data such as an internet protocol address of the requester, the requester's name (if entered somewhere on the website), and the type of Internet browser being used are within the HTTP request. In the preferred embodiment, this data elements definition for HTTP request would pull out those pieces of data.

These data elements definitions enable the checkpoint processing engine to parse the event data. If the event data captured matches a pre-existing or user-defined data elements definition, then the checkpoint processing engine applies the definition and creates data elements in step 168. Creating the data elements means applying the definition to fill in what each piece of the data element definition is in the particular event that has been captured. In the preferred embodiment, data elements definitions may be edited to suit the user of the checkpoint processing engine's specification. In the preferred embodiment, numerous data elements definitions are available to correctly process various types of event data.

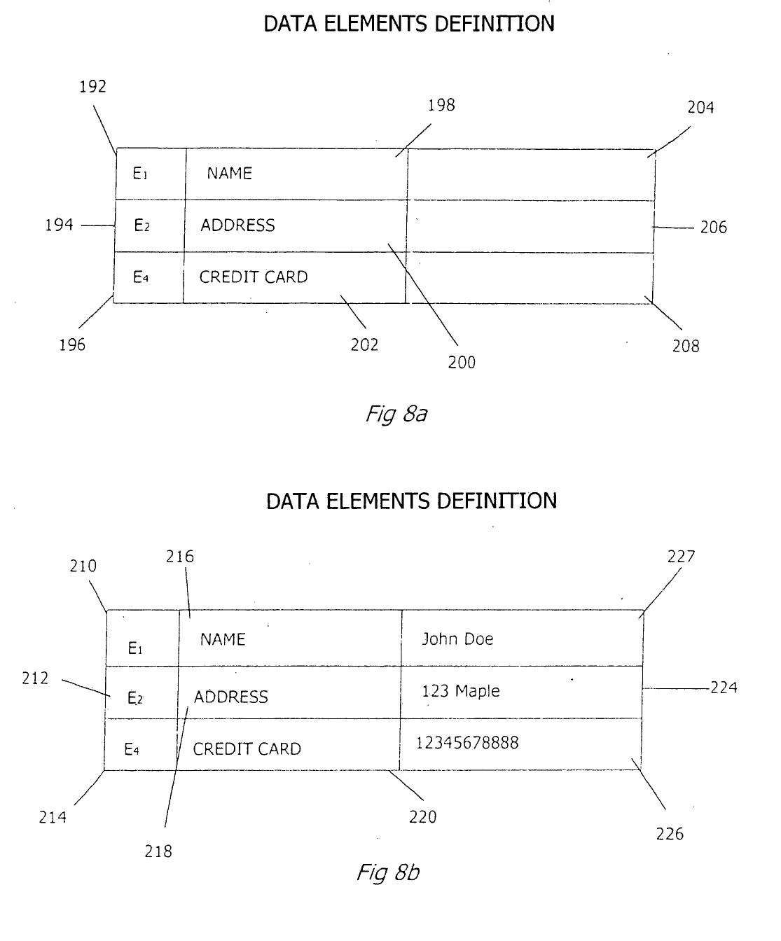

Referring to FIG. 8a, an abstract depiction of an example data elements definition is depicted. The data elements definition is more than a table to be filled with the proper data. It is a rule set or template that “knows” where to look for particular data based on the format of that data. In FIG. 8, each element from FIG. 5 is not included. FIG. 5 is representative of all of the data in an entire transaction. FIG. 8 is representative of one event's data. So, for ordering a book online, elements E₁ 192, E₂ 194 and E₄ 196, the name 198, address 200 and credit card number 202 respectively, may be the only data elements included in the credit card processing checkpoint. The data element definition “knows” that each of these three elements are included in this transaction and knows where to find them in the event data. When received, the event data is formatted in a certain way. The checkpoint processing engine uses a data element definition to find the desired data within the raw data, to pull that selected data out and to format it accordingly for later correlation to a completed instance of a business activity. In the abstract the completed table from FIG. 8a would include the name of the individual 204, their address 206 and their credit card number 208 for a completed checkpoint. This data is formatted and stored according to the desires of the user. In the preferred embodiment, the data is stored using extended markup language (XML) for later correlation to a completed instance of a business activity.

Referring now to FIG. 8b, an abstract data structure once the data elements definition has been applied is depicted. The same three elements E₁ 210, E₂ 212 and E₄ 214 are depicted. They are name 216, address 218 and credit card number 220 respectively. Now, the name John Doe 222, address 123 Maple in element 224 and the credit card number 12345678888 in element 226 are depicted. This event data was pulled out of an event data using the data elements definition and has now been formatted for later correlation to a completed instance of a business activity. In the preferred embodiment, the data is formatted using XML and includes a unique tag for the particular event data. In alternative embodiments, the data may be stored as text, in binary or in any number of other formats. The formatted data is then stored to a log.

A data elements definition exists, for example, for a hypertext transfer protocol request including data concerning a particular instance of a business activity. An actual portion of a hypertext transfer protocol request data may include text similar to the following when received by the checkpoint processing engine:
https://www.internetsite.com/application.aspx&FirstName=Joh n&txtLastName=Doe&txtAddress=123 Maple&txtCreditCard=12345678888

In the preferred embodiment, the checkpoint processing engine would remove the various elements and store them in an XML format similar to the following:

<FirstName>

<![CDATA[John]]>

</FirstName>
<LastName>

<![CDATA[Doe]]>

</LastName>
<Address>

<![CDATA[123 Maple]]>

</Address>
<CreditCard>

<![CDATA[12345678888]]>

</CreditCard>

The data need not be received by the event capture engine in the format depicted above. Rule sets and scripts are designed to correctly pull relevant event data out of event data formatted in many different ways based on the type of event being monitored and the server on which the event is taking place.

Referring again to FIG. 7, if the data does not match a pre-existing or user-defined data elements definition or once the data elements have been parsed, the checkpoint processing engine checks to see if a cluster definition exists 170. If one does exist, the checkpoint processing engine creates the cluster elements 172. The cluster definition is a definition of the type of event data that is being generated and where it came from. There may or may not be a specific data elements definition, but the event data may have come from a specific web server as a result of a known type of request. The checkpoint processing engine will then cluster those types of requests together so that a user of the checkpoint processing engine can easily see what event data was generated and where it came from. This could be a series of web page requests from a web server or web server cluster. The event data would be saved, as it is, and grouped according to the type of request and the particular server. It could also be grouped by a particular group of servers. This will enable a user of this data to determine what type of event data is being generated and to have it grouped in some systematic way.

Once the cluster elements have been created or once this step has been completed and no cluster definition existed, the checkpoint processing engine begins executing pre-processing actions 174 if any exist. Pre-processing actions are usually scripts designed to modify the event data captured to fit a specific format for correlation with an overall instance of a business activity or completed transaction.

Next, the checkpoint, along with any event data captured or cluster data into which it has been organized is correlated to a particular instance of a business activity or transaction 178. This step is done using the method and apparatus of the co-pending application entitled Transaction Processing Engine filed on Jan. 30, 2004 with Ser. No. 60/540,962.

Next, the checkpoint processing engine determines if there are any data validation rules that have been defined 180. The event data that has been captured is then validated using any number of rules. The data may be cross-checked against data in other databases, the data may be validated using any custom script to ensure its accuracy and proper format for later use. The checkpoint processing system may also check to determine if data input by a user on a webpage is in the proper format to be input directly into another system to which that data will subsequently be passed, such as a credit card server or shipping processing server. If data validation rules exist, the data is validated 182. During the validation step errors that are sent back by a particular system being monitored may also be validated or ignored. The user may customize the checkpoint processing engine's response to a particular event from a particular server or type of server.

Next, the checkpoint processing engine checks to see if any post-processing actions need to be performed 184. If so, then it performs the post-processing actions 186. These are usually of one of two types. They may be action rules or corrective actions scripts. An action script will simply perform additional functions with the collected event data that may or may not be associated with the checkpoint processing engine. The action script may log the data to a particular server or database. The action script may send an email when a particular sale occurs on a website. Action scripts may do any number of things. A corrective action script may be used if an error is detected during validation and there is a corrective action script designed to correct the problem, such as a leading space in the data of a “name” data element. An example of a corrective action script could correct, for example, the name data element contained “Carl Williams” to “Carl Williams”. A corrective action script can be applied to correct this problem.

Finally, the checkpoint processing engine creates a log and saves the data that has been parsed into that log 188. The checkpoint processing engine has then completed 190 for one piece of event data. The entire process takes only a small fraction of a few seconds to complete and is performed for each piece of event data received by the checkpoint processing engine.

Accordingly, a checkpoint processing engine has been described. It is to be understood that the foregoing description has been made with respect to specific embodiments thereof for illustrative purposes only. The overall spirit and scope of the present invention is limited only by the following claims, as defined in the foregoing description.

1. A method of processing event data within an instance of a business activity comprising the steps of:
receiving event data;
collecting relevant data from said event data;
processing said relevant data; and
storing said relevant data.

2. A digital computer system programmed to perform the steps specified in the method of claim 1.

3. Computer-readable media containing programming designed to accomplish the method of claim 1.

4. The method of claim 1, wherein said collecting step is accomplished using a rule set.

5. The method of claim 1, wherein said collecting step is accomplished using a script.

6. The method of claim 1, wherein said storing step is accomplished by storing said event data in extended markup language.

7. The method of claim 1, further comprising the step of repeating said receiving, collecting, processing and storing steps for a plurality of events in the instance of a business activity.

8. The method of claim 1, wherein said collecting step is accomplished using at least one data elements definition.

9. The method of claim 1, wherein said collecting step is accomplished using at least one cluster definition.

10. The method of claim 1, wherein said processing step further includes pre-processing of said relevant data.

11. The method of claim 10, further comprising the step of validating said relevant data.

12. The method of claim 11, further comprising the step of post processing actions.

13. A method of processing event data within an instance of a business activity comprising the steps of:
receiving event data;
collecting relevant data from said event data using a rule set;
processing said relevant data;
storing said relevant data in extended markup language; and
validating daid relevant data.

14. A digital computer system programmed to perform the steps specified in the method of claim 13.

15. Computer-readable media containing programming designed to accomplish the method of claim 13.

16. A method of processing event data within an instance of a business activity comprising the steps of:
receiving event data;
collecting relevant data from said event data using a script;
processing said relevant data;
storing said relevant data in extended markup language; and
validating said relevant data.

17. A digital computer system programmed to perform the steps specified in the method of claim 16.

18. Computer-readable media containing programming designed to accomplish the method of claim 16.

19. A method of processing event data within an instance of a business activity comprising the steps of:
Receiving event data;
Applying at least one data elements definition to said event data; and
Saving said event data.

20. A digital computer system programmed to perform the steps specified in the method of claim 19.

21. Computer-readable media containing programming designed to accomplish the method of claim 19.

22. The method of claim 19, further comprising the step of performing pre-processing actions.

23. The method of claim 19, further comprising the step of validating the event data.

24. The method of claim 19, further comprising the step of performing post-processing actions.

25. A method of processing event data within an instance of a business activity comprising the steps of:
Receiving event data;
Applying at least one cluster definition to said event data; and
Saving said event data.

26. A digital computer system programmed to perform the steps specified in the method of claim 25.

27. Computer-readable media containing programming designed to accomplish the method of claim 25.

28. The method of claim 25, further comprising the step of performing pre-processing actions.

29. The method of claim 25, further comprising the step of validating the event data.

30. The method of claim 25, further comprising the step of performing post-processing actions.

31. The computer-based apparatus for processing event data within an instance of a business activity comprising:
reception means for receiving event data;
collection means for collecting relevant event data from said event data;
processing means for processing said relevant data; and
storage means for storing said relevant data.

32. The apparatus of claim 31, wherein said collection means uses a rule set to collect said relevant data.

33. The apparatus of claim 31, wherein said collection means uses a script to collect said relevant data.

34. The apparatus of claim 31, wherein said storage means stores said event data in extended markup language.

35. The apparatus of claim 31, further comprising repetition means for processing each event in an instance of a business activity.

36. The apparatus of claim 35, further comprising additional repetition means for processing each of said instance of a business activity.

37. The apparatus of claim 31, wherein said collection means step uses at least one data elements definition.

38. The apparatus of claim 31, wherein said collection means uses at least one cluster definition.

39. The apparatus of claim 31, wherein said processing means further includes pre-processing means for performing pre-processing of said relevant data.

40. The apparatus of claim 39, further comprising validation means for validating said relevant data.

41. The apparatus of claim 41, further comprising post-processing means for performing post-processing of said relevant data.
